(19) United States
(12) Patent Application Publication
(10) Pub. No.: US 2026/0268601 A1
(43) Pub. Date: Sep. 10, 2026

(54) SYSTEMS AND METHODS FOR FACIAL ANIMATIONS

(71) Applicant: Activision Publishing, Inc., Santa Monica, CA (US)

(72) Inventors: Hasnain Salim VOHRA, North Hollywood, CA (US); Xianchun WU, Culver City, CA (US); Yiwen HUANG, Providence, RI (US)

(21) Appl. No.: 19/070,336

(22) Filed: Mar. 4, 2025

(51) Int. Cl. G06T 17/20; G06T 13/40

(52) U.S. Cl. CPC G06T 17/20; G06T 13/40

(57) ABSTRACT

A system may obtain a stereographic actor video. A system may create a dense facial mesh from the stereographic actor video. A system may obtain a model facial mesh. A system may select a plurality of dense landmark locations in the dense facial mesh. A system may select a plurality of model landmark locations in the model facial mesh. A system may map a model facial mesh to the dense facial mesh at a plurality of shared landmark locations with a non-rigid registration. A system may keypoint tracking a mapped mesh in two-dimensional space for a plurality of frames of the stereographic actor video. A system may output a per-frame tracked model facial mesh.

### CROSS-REFERENCE TO RELATED APPLICATIONS

N/A

### BACKGROUND

Animation of facial features and expressions is a cornerstone of digital animation. Accurate representation of subtle facial movements is needed for communicative and convincing representations, and manual animation or manipulation of three-dimensional models is time-consuming and can be imprecise or inaccurate. Accurate mapping and tracking of key locations between a human actor and a three-dimensional model created by digital artists can improve the quality and speed of animations.

### SUMMARY

In some aspects, the techniques described herein relate to a method of facial animation, the method including: obtaining a stereographic actor video; creating a dense facial mesh from the stereographic actor video; obtaining a model facial mesh; selecting a plurality of dense landmark locations in the dense facial mesh; selecting a plurality of model landmark locations in the model facial mesh; mapping a model facial mesh to the dense facial mesh at a plurality of shared landmark locations with a non-rigid registration; keypoint tracking a mapped mesh in two-dimensional space for a plurality of frames of the stereographic actor video; and outputting a per-frame tracked model facial mesh.

In some aspects, the techniques described herein relate to a system for facial animation, the system including: a head-mounted camera (HMC) system including: a first camera at a first orientation, and a second camera at a second orientation; and a computing device in data communication with the HMC system, the computing device including: a processor, and a hardware storage device in data communication with the processor and having instructions stored configured to, when executed by the processor, cause the computing device to: obtain a stereographic actor video from the HMC system, create a dense facial mesh from the stereographic actor video, select a plurality of dense landmark locations in the dense facial mesh, select a plurality of model landmark locations in the model facial mesh, map a model facial mesh to the dense facial mesh at a plurality of shared landmark locations with a non-rigid registration, and keypoint track a mapped mesh in two-dimensional space for a plurality of frames of the stereographic actor video.

In some aspects, the techniques described herein relate to a method of facial animation, the method including: obtaining a stereographic actor video; creating a dense facial mesh from the stereographic actor video; selecting a plurality of dense landmark locations in the dense facial mesh with a machine learning model; selecting a plurality of model landmark locations in the model facial mesh with a machine learning model; mapping a model facial mesh to the dense facial mesh at a plurality of shared landmark locations with a non-rigid registration including differentiable rendering of the model facial mesh, wherein mapping the model facial mesh to the dense facial mesh includes a loss function including a Laplacian loss term, a landmarks loss term, a depth loss term, and a normal loss term; keypoint tracking a mapped mesh in two-dimensional space for a plurality of frames of the stereographic actor video; and outputting a per-frame tracked model facial mesh.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and aspects of embodiments of the disclosure will be set forth in the description which follows, and in part will be obvious from the description, or may be learned by the practice of such embodiments. The features and aspects of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a perspective view of a head-mounted capture system, according to at least some embodiments of the present disclosure.

FIG. 2 is a flowchart illustrating a method of animating a facial mesh, according to at least some embodiments of the present disclosure.

FIG. 3 is a system diagram illustrating a plurality of loss functions for tracking a model facial mesh, according to at least some embodiments of the present disclosure.

FIG. 4 is a schematic representation of a sliding window projection for keypoint tracking, according to at least some embodiments of the present disclosure.

FIG. 5 is a flowchart illustrating a decision tree, according to at least some embodiments of the present disclosure.

FIG. 6 is a system diagram of a system for animating a facial mesh, according to at least some embodiments of the present disclosure.

FIG. 7 is a flowchart illustrating a machine learning model, according to at least some embodiments of the present disclosure.

### DETAILED DESCRIPTION

The present disclosure relates generally to facial animation of three-dimensional (3D) meshes. More particularly, the present disclosure relates to facial animation of 3D meshes based on human actors. In some embodiments, systems and methods according to the present disclosure match a model facial mesh to a dense facial mesh. The model facial mesh is a relatively lower-resolution 3D mesh of a digital model, and the dense facial mesh is a higher-resolution 3D mesh captured from a human actor. In some embodiments, the dense facial mesh is created from a stereoscopic camera system recording a human actor. For example, a human actor may be recorded with a head-mounted camera system including a plurality of cameras. The plurality of cameras captures a stereoscopic video of the human actor. The dense facial mesh is calculated from the stereoscopic video.

In some embodiments, the dense facial mesh is unwieldly to animate directly. For example, the dense facial mesh may include hundreds of thousands or even millions of vertices. The dense facial mesh, therefore, may capture subtle expressions or movement in the human actor's face recorded in the stereographic video. However, the computational demands to animate and render digital models at the resolution of the dense facial mesh may be impractical for real-time rendering on consumer hardware.

A model facial mesh, in some embodiments, has less vertices and lower resolution than the dense facial mesh. The model facial mesh has at least one order of magnitude less vertices relative to the dense facial mesh. For example, the model facial mesh may include tens of thousands of vertices. Such reduction in resolution may allow a greater range of computing devices and/or processors to render the model facial mesh in real-time in a software application, such as an interactive software application. In some examples, the model facial mesh is rendered in real-time during an interactive software application such as an interactive game application.

In some embodiments, the model facial mesh is mapped to and tracked to the dense facial mesh through differentiable rendering of the model facial mesh. The differentiable rendering allows the mapping of the model facial mesh through a gradient descent that approximates the dense facial mesh without substantial or any input from a user. A loss function including a plurality of terms, as will be described herein, ensures the model facial mesh remains close to the original geometry during the mapping process. In some embodiments, the mapped model facial mesh can then be animated to move with the recording dense facial mesh movements through a tracking of keypoints in each. The mapping of the model facial mesh according to at least some of the methods described herein enables the tracking to animate the model facial mesh more accurately in a shorter amount of time.

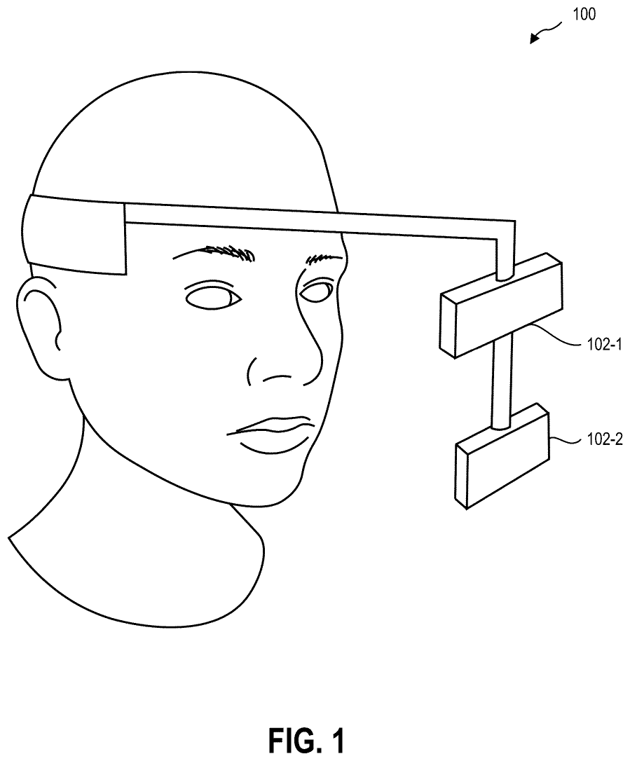

FIG. 1 illustrates a head-mounted camera (HMC) system 100 that includes a plurality of cameras 102-1, 102-2 configured and positioned to capture the face of a human actor at different perspectives. In some embodiments, a first camera 102-1 is positioned in an upper position and a second camera 102-2 is positioned in a lower position, whereby the first camera 102-1 captures a first video of the human actor from an upper perspective and the second camera 102-2 captures a second video of the human actor from a lower perspective. In some embodiments, a first camera 102-1 is positioned in a left position (relative to the actor's face) and a second camera 102-2 is positioned in a right position, whereby the first camera 102-1 captures a first video of the human actor from a left perspective and the second camera 102-2 captures a second video of the human actor from a right perspective. In some embodiments, a first camera 102-1 is positioned in an upper-left position and a second camera 102-2 is positioned in a lower-right position, whereby the first camera 102-1 captures a first video of the human actor from an upper-left perspective and the second camera 102-2 captures a second video of the human actor from a lower-right perspective.

However, the first camera 102-1 and the second camera 102-2 are positioned relative to the human actor, the first camera 102-1 and the second camera 102-2 remained fixed relative to the human actor and relative to one another at a known orientation. The first video and the second video are, therefore, captured at a known orientation relative to the human actor as the human actor provides a performance. The first video and the second video are synchronized such that any movements of the human actor's face are present in the first video and second video, allowing for the creation of a stereographic video including the first video and second video.

In some embodiments, the HMC system 100 is calibrated using a calibration board, such as a checkerboard or circular pattern. In some examples, the calibration board is 10×10 mm, 15×15 mm, or another similar size. In some embodiments, a stage operator puts the calibration board in the view of the plurality of cameras and takes a video of the calibration board in different positions and orientations. In some embodiments, the stage operator typically calibrates the cameras at-least three times during the shoot day (for example once at 11 am, once at 2 pm and once at 4 pm). In some embodiments, the calibration process outputs the camera matrix, the distortion coefficients, rotation and translation vectors, and the reprojection error of the HMC to allow for corrections to the videos and/or stereographic video captured of the human actor's face. In some embodiments, the calibration process is run for each of the three calibration videos taken during the day and the take with the lowest reprojection error is selected. After calibration, the stereographic video can be collected and processed.

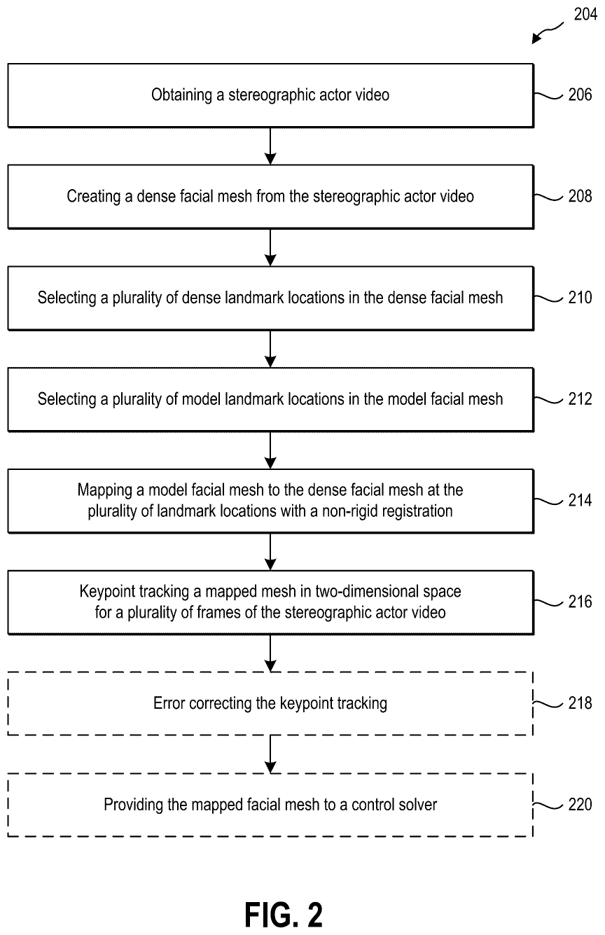

FIG. 2 is a flowchart illustrating an embodiment of a method of animating a model facial mesh, according to the present disclosure. The method 204 includes obtaining a stereographic actor video at 206. As described in relation to FIG. 1, in some embodiments, the stereographic actor video is obtained from a HMC system. In some embodiments, the stereographic actor video is obtained from a plurality of cameras in a motion capture stage. In some embodiments, the stereographic actor video is obtained from a server or other remote computing device on which the stereographic actor video is stored. For example, obtaining the stereographic actor video may include accessing a remote hardware storage device. In some embodiments, the stereographic actor video includes depth information. In some embodiments, the stereographic actor video includes a first video track and a second video track.

The method 204 further includes creating a dense facial mesh from the stereographic actor video at 208. The dense facial mesh is calculated from the stereographic actor video by extracting a plurality of frames from the video, starting from a first frame. In some embodiments, the first frame is selected by the artist. In some embodiments, the first frame is selected based on a neutral expression. For example, the method 204 may include comparing the actor's facial expression in the stereographic actor video to a neutral facial expression template, and a frame having the least deviation or difference from the neutral expression template may be automatically selected as the first frame. In some embodiments, the top and bottom HMC images of the first frame are then rectified and undistorted using the camera matrices and the distortion coefficients established during calibration.

In some embodiments, creating the dense facial mesh further includes segmenting the rectified and/or undistorted HMC images of the first frame with a bilateral segmentation network. In some examples, the bilateral segmentation network parses the actor's face from the background information of the first frame. In some examples, the bilateral segmentation network further parses portions or regions of the actor's face, such as eyes, lips, eyebrows, nose, etc. from other portions of the actor's face. Creating the dense facial mesh further includes computing a disparity map based on the plurality of images of the first frame. The disparity map is subsequently converted to depth information based at least partially on the HMC geometry and known displacement between the plurality of cameras and known distance from the actor's face.

Creating the dense facial mesh, in some embodiments, includes triangulating a depth map using a Poisson Surface Reconstruction. The dense mesh is subsequently transformed to the original camera space of the HMC system. In some embodiments, the dense facial mesh includes at least 50,000 vertices. In some embodiments, the dense facial mesh includes at least 80,000 vertices. In some embodiments, the dense facial mesh includes 100,000 vertices. In some embodiments, the dense facial mesh includes at least 1,000,000 vertices.

After construction of the dense facial mesh, the method may optionally include determining an optical flow between frames of the stereographic actor video. In some embodiments, the optical flow is calculated using an artificial neural network, such as a recurrent neural network, or another machine learning model. In some embodiments, the optical flow is later utilized in a Laplacian Solver to minimize one or more loss functions, as will be described in more detail herein.

The method 204 further includes selecting a plurality of dense landmark locations in the dense facial mesh at 210. In some embodiments, the method includes selecting a sparse map of facial landmarks in the dense facial mesh by a video landmark detection network. In some embodiments, the video landmark detection network is configured to detect at least 98 landmarks. In some embodiments, the video landmark detection network is configured to detect at least 54 landmarks. In some embodiments, the video landmark detection network selects landmarks proximate to at least the lateral edges of the mouth, the lateral edges of the eyes, the lateral edges of the nose, the vertical edges of the mouth, the vertical edges of the eyes, the vertical edges of the nose, or combinations thereof. In some embodiments, selecting a plurality of dense landmark locations includes manually annotating at least a portion of the plurality of dense landmark locations.

In some embodiments, the method 204 further includes obtaining a model facial mesh at 212. In some embodiments, obtaining a model facial mesh includes obtaining a three-dimensional morphable model (3DMM). In some embodiments, obtaining the model facial mesh includes accessing a stored model facial mesh on a local hardware storage device. In some embodiments, obtaining the model facial mesh includes accessing a stored model facial mesh on a remote hardware storage device. In some embodiments, obtaining a model facial mesh includes segmenting a model facial mesh from a model mesh of an complete digital model of a virtual avatar or other virtual character. In some embodiments, the model facial mesh is lower-resolution and/or has a lesser quantity of vertices than the dense facial mesh. In some embodiments, the model facial mesh has less than 50,000 vertices. In some embodiments, the model facial mesh has less than 20,000 vertices. In some embodiments, the model facial mesh has less than 10,000 vertices. In at least one embodiment, the model facial mesh has less than one order of magnitude less vertices than the dense facial mesh. For example, for a dense facial mesh including 100,000 vertices, the model facial mesh has less than 10,000 vertices. In another examples, for a dense facial mesh including 500,000 vertices, the model facial mesh has less than 50,000 vertices.

The method 204, in some embodiments, further includes selecting a plurality of model landmark locations in the model facial mesh at 214. In some embodiments, the method includes selecting a sparse map of facial landmarks in the model facial mesh by a video landmark detection network. In some embodiments, the plurality of model landmark locations is based on the dense landmark locations. In some embodiments, the plurality of model landmark locations is the same as the plurality of dense landmark locations. In some embodiments, the plurality of model landmark locations has a quantity of landmark location that is the same as the plurality of dense landmark locations. In some embodiments, model landmark locations are proximate to at least the lateral edges of the mouth, the lateral edges of the eyes, the lateral edges of the nose, the vertical edges of the mouth, the vertical edges of the eyes, the vertical edges of the nose, or combinations thereof. In some embodiments, selecting a plurality of model landmark locations includes manually annotating at least a portion of the plurality of model landmark locations.

The method 204 further includes mapping the plurality of model landmark locations to the plurality of dense landmark locations of at least a first frame of the stereographic actor video with a non-rigid registration at 216. In some embodiments, the plurality of model landmark locations and the plurality of dense landmark location are mapped across a plurality of shared landmark locations. In some examples, the plurality of shared landmark locations includes all of the model landmark locations and all of the dense landmark locations. In some examples, the plurality of shared landmark locations includes less than all of the model landmark locations. In some examples, the plurality of shared landmark locations includes less than all of the dense landmark locations.

In some embodiments, the non-rigid registration includes a differentiable renderer. Differentiable rendering, as will be described herein, performs a non-rigid registration of the model facial mesh to the dense facial mesh. In contrast to an iterative closest-point (ICP) algorithm for point cloud registration, differentiable rendering allows for different aspect of the model to be rendered individually.

Conventional ICP algorithms typically operate by iteratively finding correspondences between two point clouds and then minimizing either a point-to-point or point-to-plane distance metric. However, these correspondence-based methods have inherent limitations. Since the correspondences represent only a sampling of the overall point clouds, the cost function in these approaches may not fully capture the global shape of the face. This can lead to suboptimal alignments, particularly in regions with sparse or inaccurate correspondences. Moreover, the reliance on accurate correspondence estimation becomes the primary point of failure for these methods. Errors in correspondence matching can propagate through the registration process, leading to significant misalignments or convergence to local minima, especially in cases of large deformations or partial occlusions.

A differentiable renderer extends conventional rendering methods by making the rendering process differentiable, such that that gradients in the mesh can be computed with respect to scene parameters. Differentiable rendering enables the calculation of 3D scene elements based on 2D image comparisons. Differentiable renderers create a computational graph of the rendering process, where each step, from geometry processing to final pixel color calculation, is differentiable. This allows for the backpropagation of gradients from rendered images to scene parameters, facilitating tasks such as 3D reconstruction, material estimation, and pose estimation from images.

Keypoint tracking the landmark locations in two-dimensional (2D) space for at least a second frame of the stereographic actor video at 218. In some embodiments, the keypoint tracking includes the projection of the landmark locations into a 2D space. The 2D space includes the stereographic actor video information from the perspective of the HMC. In some embodiments, by projecting the landmark locations into the 2D space, the landmark locations can be defined by less parameters in subsequent frames of the stereographic actor video. The projection into 2D space, therefore, can reduce the computational demands on the rendering of the model facial mesh according to the landmark locations.

The method 204, in some embodiments, optionally includes error correction at 220. The differentiable renderer is also used for error correction in conjunction with the Laplacian solver. The three main sources of deformation in the Laplacian solver are also the sources that introduce error. Error can originate in the optical ow estimation, the keypoint tracking and the landmark detection. The differentiable renderer is used with the same cost function as above to correct the errors introduced by the Laplacian solver. It is used in a loop with the Laplacian solver until the error is below a predetermined threshold value.

The Laplacian Solver is a linear least-squares solver that takes the tracked points from the keypoint tracker, optical output, and landmarks and uses the per-frame dense reconstruction to transfer the tracked points to the game mesh. The Laplacian Solver, therefore, minimizes the variance between the dense mesh of the actor video and the model facial mesh across animation of a plurality of frames as the dense facial mesh moves with the actor's performance. In some embodiments, the Laplacian Solver finds a solution to the following equation:

$$E ( {X}^{t} ) = {\sum }_{i = 1}^{n} ‖ {L}_{s} {X}^{t} - {L}_{s} {X}^{{t}_{0}} ‖ + {λ}_{s} {\sum }_{i = 1}^{n} ‖ {X}_{i}^{t} - {S}_{i}^{t} ‖ {W}_{i}^{t} + {λ}_{l} {\sum }_{i = 1}^{n} ‖ {X}_{i}^{t} - {L}_{i}^{t} ‖ {W}_{i}^{t} + {λ}_{k} {\sum }_{i = 1}^{n} ‖ {X}_{i}^{t} - {K}_{i}^{t} ‖ {W}_{i}^{t}$$

wherein

$${\sum }_{i = 1}^{n} ‖ {L}_{s} {X}^{t} - {L}_{s} {X}^{{t}_{0}} ‖$$

is a Laplacian term measuring the divergence in a gradient between frames of the stereographic actor video,

$${λ}_{s} {\sum }_{i = 1}^{n} ‖ {X}_{i}^{t} - {S}_{i}^{t} ‖ {W}_{i}^{t}$$

is a scene flow term incorporating the optical flow calculated from the stereographic actor video,

$${λ}_{l} {\sum }_{i = 1}^{n} ‖ {X}_{i}^{t} - {L}_{i}^{t} ‖ {W}_{i}^{t}$$

is a landmarks term to minimize differences in landmark positions between frames of the stereographic actor video, and

$${λ}_{k} {\sum }_{i = 1}^{n} ‖ {X}_{i}^{t} - {K}_{i}^{t} ‖ {W}_{i}^{t}$$

is a keypoints term to minimize displacements of the keypoints in the keypoint tracker during the plurality of frames in the stereographic actor video.

The method 204, optionally, includes a control solver at 222. In some embodiments, the Animation Controls Solver suite is designed to find optimal control values for a rig to approximate the vertex positions of an animated mesh. Its objective is to take results from the facial mesh solver (i.e., an animated mesh) and output animation control curves (which are easier for an artist to edit than blend shape weights). In some embodiments, the output of the method 204 of FIG. 2 is a per-frame tracked model facial mesh.

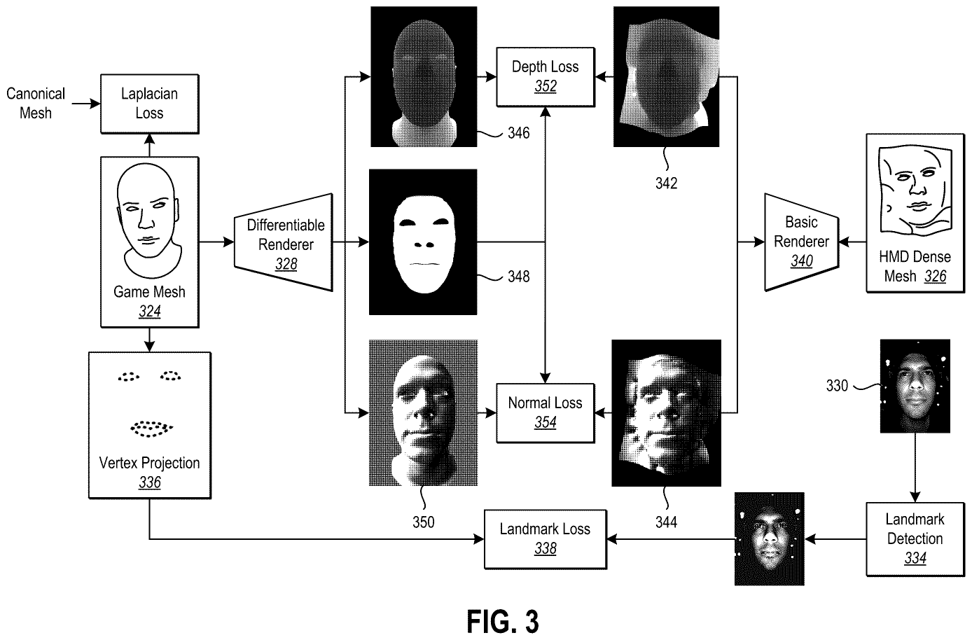

FIG. 3 is a schematic illustration of the mapping of a model facial mesh 324 to the dense facial mesh 326 with a non-rigid registration. The mapping of the model facial mesh 324 to the dense facial mesh 326, in some embodiments, uses a differentiable renderer 328 to create different maps for comparing the model facial mesh 324 to the dense facial mesh 326 in different loss functions. The non-rigid registration of the point clouds is performed by minimizing a loss function including a Laplacian loss term, a landmark location loss term, a depth loss term, and a normal loss term. For example, the loss function may be according to:

$$E ( {V}_{g} ) = {λ}_{Laplacian} {E}_{Laplacian} + {λ}_{landmark} {E}_{landmark} + {λ}_{depth} {E}_{depth} + {λ}_{normal} {E}_{normal}$$

The above loss function may be used to map the game mesh to the dense mesh. The Laplacian loss term relates to the relative curvature of the model facial mesh relative to the dense facial mesh, such that the mapped facial mesh retains the overall shape and structure of the original (unmapped) model mesh. The landmark loss term relates to alignment between the landmark points of the model facial mesh and the dense facial mesh. The depth and normal loss terms compare the depth and normal direction (i.e., surface orientation) images of the model facial mesh with those of the dense facial mesh, ensuring that the mapped facial mesh aligns with the dense facial mesh in terms of depth and surface orientation. In some embodiments, each term of the loss function may be individually weighted to allow tuning of the mapping, even when automated. In some embodiments, the non-rigid registration of the point clouds includes a calculating a rigid registration of at least a portion of the point cloud to begin the process with a set of approximate locations. For example, a rigid registration may be performed on the entire point cloud. In other examples, a portion of the point cloud, such as the nose, a forehead, or a cheekbone may be selected for the rigid registration before a non-rigid registration of other portions of the point cloud and/or refinement of the original rigid registration.

In some embodiments, the HMC image 330 is obtained from the stereographic video, and the HMC image 330 is used to create the dense facial mesh 326, as described herein. In some embodiments, the HMC image 330 is provided to a machine learning model or other landmark detection model 334 to detect dense landmarks. A plurality of model landmarks are determined from the model facial mesh 324, in some examples, by vertex projection 336. In some embodiments, the plurality of model landmarks are based at least partially on the detected dense landmarks. The plurality of dense landmarks and the plurality of model landmarks are compared in the landmark loss term 338.

In some embodiments, the model facial mesh 324 is evaluated by a differentiable renderer 328 and the dense facial mesh 326 is evaluated by a basic renderer 340. The basic renderer 340 generates a dense depth map 342 and a dense normal map 344. The differentiable renderer 328 generates a model depth map 346, a model facial mask 348, and a model normal map 350. In some embodiments, the model depth map 346 is compared to the dense depth map 342 to determine a depth loss term 352. In some embodiments, the model normal map 350 is compared to the dense normal map 344 to determine a normal loss term 354.

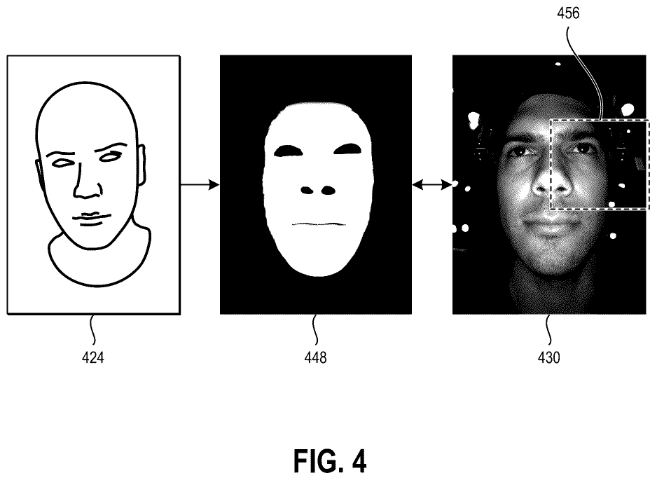

FIG. 4 illustrates a comparison of the model facial mesh 424 and a representative HMC image 430 for keypoint tracking. In some embodiments, the keypoint tracking module is or includes a machine learning model-based (e.g., a neural network) point-tracking method, which tracks discrete points in a video. Keypoint tracking is initialized by sampling points on the model facial mesh 424 after differentiable rendering of the model facial mesh and then projecting those points from 3D to 2D at the start frame. A model facial mask 448 (such as the model facial mask 348 described in relation to FIG. 3) on top of the model facial mesh 424 discriminates between points included in the sampling and those excluded. In some embodiments, only points on the frontal part of the face are included and points around the eyes and mouth are excluded, as those regions tend to undergo significant appearance changes. Additionally, the points of the eyes and mouth (particularly the teeth) are not subject to stretch, compression or other distortion during movement, speech, or other actions.

In some embodiments, points are sampled on the mesh using a Poisson disk sampling method to ensure that the points are evenly distributed on the model facial mesh. Points along the edge of the model facial mask 448 are also sampled to ensure that the model facial mesh 424 does not drift relative to the actor's face in the HMC image(s) 430 during tracking. In at least one embodiment during testing, the machine learning model of the keypoint tracking receives a fixed input size of 256×256 pixels. In some examples, the HMC images 430 are much larger resolution, such as 2048×1536 pixels. In some embodiments, the relatively large HMC image 430 is resampled to fit to a 256×256-pixel window. In some embodiments, providing the HMC image 430 to the machine learning model of the keypoint tracking includes using a sliding window 456 of 256×256 pixels to crop multiple 256×256 windows from the larger image. In some examples, the windows are captured at 0.5 and 0.25 scales. In such embodiments, the keypoints projected from the model facial mesh 424 are tracked in whichever window of the multiple windows in which the keypoints first appear. After tracking these keypoints in multiple windows, in some embodiments, the method includes a strong consensus filter to determine the final position of the tracked keypoint. If the position of a point is not consistent across multiple windows in a sequence of HMC images 430 (e.g., a sequence of frames of the stereographic video), then the keypoint is discarded in those frames. During testing, it was found that the sliding window approach is more robust than resampling the image to fit a 256×256 window based at least partially on the higher resolution of the tracked keypoints, while resampling the image to a lower resolution, in some embodiments, demands less computational resources.

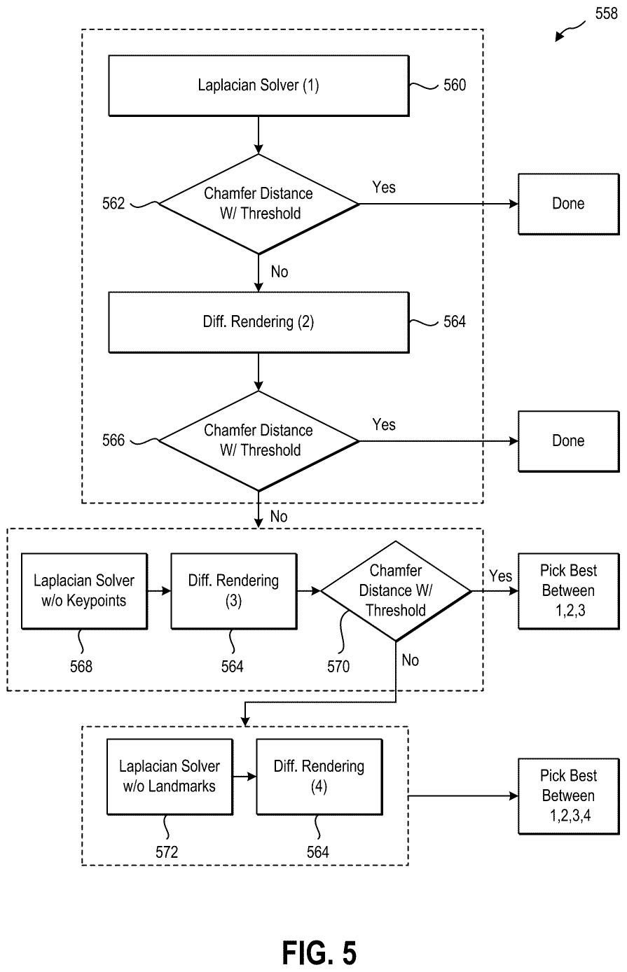

FIG. 5 is a flowchart illustrating a method 558 of refining keypoint tracking. In some embodiments, the method 558 is used in conjunction with an embodiment of the method 204 described in relation to FIG. 3. In some embodiments, the method 558 describes at least one version of the error correction described in relation to FIG. 3. For example, the method 558 may begin with the Laplacian Solver described in relation to FIG. 3. More specifically, the Laplacian Solver may find a solution to the following equation:

$$E ( {X}^{t} ) = {\sum }_{i = 1}^{n} ‖ {L}_{s} {X}^{t} - {L}_{s} {X}^{{t}_{0}} ‖ + {λ}_{s} {\sum }_{i = 1}^{n} ‖ {X}_{i}^{t} - {S}_{i}^{t} ‖ {W}_{i}^{t} + {λ}_{l} {\sum }_{i = 1}^{n} ‖ {X}_{i}^{t} - {L}_{i}^{t} ‖ {W}_{i}^{t} + {λ}_{k} {\sum }_{i = 1}^{n} ‖ {X}_{i}^{t} - {K}_{i}^{t} ‖ {W}_{i}^{t}$$

wherein

$${\sum }_{i = 1}^{n} ‖ {L}_{s} {X}^{t} - {L}_{s} {X}^{{t}_{0}} ‖$$

is a Laplacian term measuring the divergence in a gradient descent between frames of the stereographic actor video,

$${λ}_{s} {\sum }_{i = 1}^{n} ‖ {X}_{i}^{t} - {S}_{i}^{t} ‖ {W}_{i}^{t}$$

is a scene flow term incorporating the optical flow calculated from the stereographic actor video,

$${λ}_{l} {\sum }_{i = 1}^{n} ‖ {X}_{i}^{t} - {L}_{i}^{t} ‖ {W}_{i}^{t}$$

is a landmarks term to minimize differences in landmark positions between frames of the stereographic actor video, and

$${λ}_{k} {\sum }_{i = 1}^{n} ‖ {X}_{i}^{t} - {K}_{i}^{t} ‖ {W}_{i}^{t}$$

is a keypoints term to minimize displacements of the keypoints in the keypoint tracker during the plurality of frames in the stereographic actor video.

In some embodiments, the Laplacian Solver 560 produces a solution output that is compared to threshold value at 562. In some embodiments, the output of the Laplacian Solver 560 is within the threshold value of the chamfer distance and the method 558 ends with the tracked model facial mesh being sufficiently close to the target. In some embodiments, the output of the Laplacian Solver 560 alone is not within the threshold value of the chamfer distance, and the method 558 iterates to the differentiable rendering 564 of the model facial mesh and compares the results of the differentiable rendering 564 (such as the depth map, normal map, etc. described in relation to FIG. 3) to a threshold value at 566.

In some embodiments, the method 558 continues from the differentiable rendering 564 when the chamfer distance is not within the threshold value to a Laplacian Solver without the keypoints term at 568 combined with the differentiable rendering 564. The results of the Laplacian Solver without the keypoints term at 568 combined with the differentiable rendering 564 is compared to the threshold value at 570. In an embodiment in which the output of the Laplacian Solver without the keypoints term at 568 combined with the differentiable rendering 564 is within the threshold value, the method 558 includes selecting the best fit output from each of the iterations of the method 558 to that point. For example, the method 558 includes selecting the best solution from the outputs of the Laplacian Solver 560, the differentiable rendering 564, and the Laplacian Solver without the keypoints term 568 combined with the differentiable rendering 564.

In some examples, a Laplacian Solver without the keypoint term at 568 allows the Laplacian Solver to solve for a simpler solution that does not require a solution for the keypoint term. The removal of the keypoints term allows for a greater likelihood of a fit of the tracked mesh relative to the Laplacian term and the optical flow term in relation to the landmarks term, with a compromise to the accuracy of the keypoint tracking. In some embodiments, the Laplacian Solver without the keypoint term at 568 is more likely to produce a tracked mesh that maintains the integrity of the model mesh.

In an embodiment in which the output of the Laplacian Solver without the keypoints term at 568 combined with the differentiable rendering 564 is not within the threshold value at 570, the method 558 further continues to the Laplacian Solver without the landmarks term 572 combined with the differentiable rendering 564. In some examples, a Laplacian Solver without the landmarks term at 572 allows the Laplacian Solver to solve for a simpler solution that does not require a solution for the landmarks term. The removal of the keypoints term allows for a greater likelihood of a fit of the tracked mesh relative to the Laplacian term and the optical flow term, with a compromise to the accuracy of the landmark matching. In some embodiments, the Laplacian Solver without the landmarks term at 572 is more likely to produce a model facial mesh that maintains the integrity of the model facial mesh at a minimum.

In some embodiments in which the output of the Laplacian Solver without the landmarks term at 572 combined with the differentiable rendering 564 is within the threshold value, the method 558 includes selecting the best solution from the outputs of the Laplacian Solver 560, the differentiable rendering 564, the Laplacian Solver without the keypoints term 568 combined with the differentiable rendering 564, and the Laplacian Solver without the landmarks term 572 combined with the differentiable rendering 564. In some embodiments, the output of the method 558 of FIG. 5 (e.g., the Laplacian Solver and/or Differentiable Rendering module) is a per-frame tracked model facial mesh.

However, since each frame's vertices are tracked independently, the tracked mesh can be subject to jitter in the output sequence of frames. In some embodiments, a principal component analysis (PCA) projection of the model facial mesh projects the tracked mesh to the canonical model facial mesh space. In some embodiments, the PCA basis is created from the blendshapes extracted of the model rig. For example, the PCA projection of the model facial mesh projects the tracked mesh in a facial blendshape space. The facial blendshapes are parameterizations of various facial expressions, allowing the mesh to move in predetermined expressions and movements to avoid improper or “unnatural” animations of the mesh that do not correspond to expected of physically relevant movements and shapes. In some embodiments, the PCA provides a per-frame tracked model facial mesh that is constrained to the PCA space. The PCA-constrained tracked model facial mesh provides PCA space parameters that can be used to derive each tracked model facial mesh from the original, canonical model facial mesh. In some embodiments, the method 558 includes providing the output to a control solver, such as described in relation to FIG. 2.

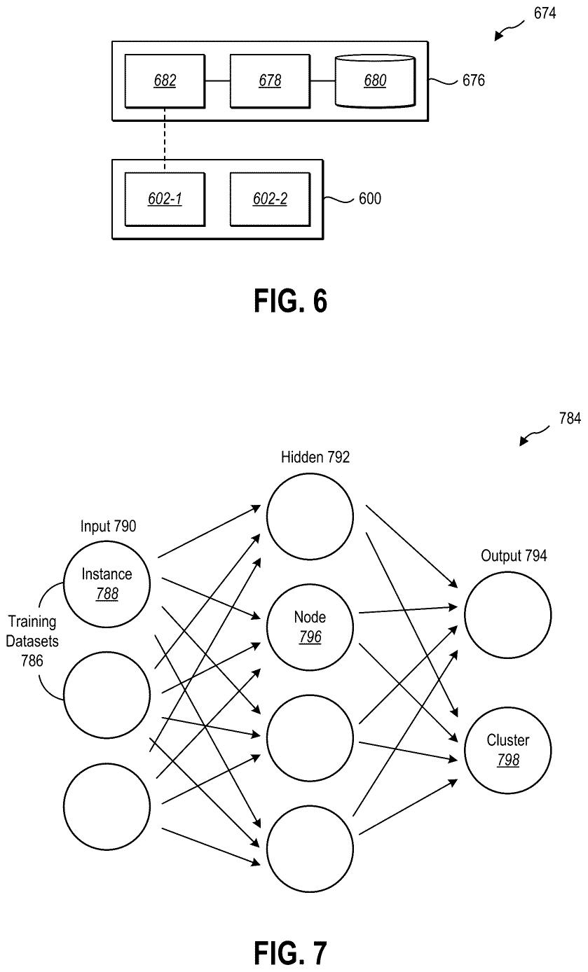

FIG. 6 is a system diagram of an embodiment of a system 674 for animating a facial mesh, according to the present disclosure. In some embodiments, the system 674 includes a computing device 676 and an HMC system 600, such as that described in relation to FIG. 1. For example, the HMC system 600 may include at least a first camera 602-1 and a second camera 602-2 positioned at known orientations relative to one another to capture the actor's face in videos.

In some embodiments, the computing device 676 includes a processor 678 in data communication with a hardware storage device 680. In some embodiments, the processor(s) 678 06 is a central processing unit (CPU) that performs general computing tasks for the computing device 676. In some embodiments, the processor(s) 678 is or is part of a system on chip (SoC) that is dedicated to controlling or communicating with one or more subsystems of the computing device 676. In some embodiments, the processor(s) 678 is an application specific integrated circuit (ASIC). In some embodiments, the processor(s) 678 is or is part of a graphical processing unit (GPU) or other processor configured to perform floating point operating procedures.

In some embodiments, the processor 106 is in data communication with the hardware storage device 680 to execute instructions stored thereon that cause the processor 678 to perform at least a portion of any of the methods described herein. For example, the hardware storage device 680 may have instructions stored thereon that, when executed by the processor 678, cause the computing device to perform all of an embodiment of the method described in relation to FIG. 2. In some embodiments, at least a portion of the method is performed by a second computing device, such as the computing device 676 communicating with a server computer that performs the recurrent neural network landmark identification, as described herein.

In some embodiments, the hardware storage device(s) 680 is a non-transient storage device including any of RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

The processor 678 may further be in data communication with a communication device 682 that provides data communication with the HMC system 600. For example, the computing device 676 may include a wireless communication device 682 to wirelessly receive the stereographic actor video and/or HMC images from the HMC system 600 or cameras 602-1, 602-2 thereof. In some examples, the computing device 676 includes a wired communication device 682 to receive the stereographic actor video and/or HMC images from the HMC system 600 or cameras 602-1, 602-2 thereof.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

In some embodiments, systems and methods according to the present disclosure include a machine learning (ML) model, ML system, or ML-based vision model to detect the landmarks (such as described in relation to FIG. 2). FIG. 7 is a flowchart of an embodiment of an ML model 784 that may be used with any of the methods described herein. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as an original model facial mesh, an HMC image, a dense facial mesh, text, graphics, audio, or other information obtained by the computing device.

In some embodiments, the machine learning system has a plurality of layers with an input layer 790 configured to receive at least one input training dataset 786 or input training instance 788 and an output layer 794, with a plurality of additional or hidden layers 792 therebetween. The training datasets can be input into the machine learning system to train the machine learning system and identify individual and combinations of labels or attributes of the training instances that allow the machine learning model to improve recognition and/or tracking of landmarks and/or keypoints. In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes 796), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 798, to the output layer.

In some embodiments, each of the nodes 796 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

It should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, to the extent such features are not described as being mutually exclusive. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. The described embodiments are therefore to be considered as illustrative and not restrictive, and the scope of the disclosure is indicated by the appended claims rather than by the foregoing description.

What is claimed is:

1. A method of facial animation, the method comprising:
obtaining a stereographic actor video;
creating a dense facial mesh from the stereographic actor video;
obtaining a model facial mesh;
selecting a plurality of dense landmark locations in the dense facial mesh;
selecting a plurality of model landmark locations in the model facial mesh;
mapping a model facial mesh to the dense facial mesh at a plurality of shared landmark locations with a non-rigid registration;
keypoint tracking a mapped mesh in two-dimensional space for a plurality of frames of the stereographic actor video; and
outputting a per-frame tracked model facial mesh.

2. The method of claim 1 further comprising providing the mapped mesh to a control solver for animation.

3. The method of claim 1, wherein mapping the model facial mesh to the dense facial mesh includes differentiable rendering of the model facial mesh.

4. The method of claim 3, wherein the differentiable rendering is only performed on a first frame of the plurality of frames.

5. The method of claim 1, wherein obtaining the stereographic actor video includes capturing a first video at an upper perspective and a second video at a lower perspective.

6. The method of claim 1, further comprising a principal component analysis projection of the model facial mesh in a facial blendshape space.

7. The method of claim 1, further comprising determining a rigid transform between the model landmark locations of the model facial mesh and the dense landmark locations of dense facial mesh before mapping the model facial mesh to the dense facial mesh.

8. The method of claim 1, wherein selecting a plurality of dense landmark locations includes providing the dense facial mesh to an artificial neural network to select the plurality of dense landmark locations.

9. The method of claim 1, wherein selecting a plurality of model landmark locations includes manually annotating the model facial mesh.

10. The method of claim 1, further comprising determining an error correction of the keypoint tracking, wherein the error correction includes differentiable rendering of the model mesh.

11. The method of claim 1, wherein mapping the model facial mesh to the dense facial mesh includes a loss function, the loss function including at least a Laplacian loss term.

12. The method of claim 11, wherein the loss function further includes a landmark location loss term.

13. The method of claim 12, wherein the loss function further includes a depth loss term and a normal loss term.

14. A system for facial animation, the system comprising:
a head-mounted camera (HMC) system including:
a first camera at a first orientation, and
a second camera at a second orientation; and
a computing device in data communication with the HMC system, the computing device including:
a processor, and
a hardware storage device in data communication with the processor and having instructions stored configured to, when executed by the processor, cause the computing device to:
obtain a stereographic actor video from the HMC system,
create a dense facial mesh from the stereographic actor video,
select a plurality of dense landmark locations in the dense facial mesh,
select a plurality of model landmark locations in the model facial mesh,
map a model facial mesh to the dense facial mesh at a plurality of shared landmark locations with a non-rigid registration, and
keypoint track a mapped mesh in two-dimensional space for a plurality of frames of the stereographic actor video.

15. The system of claim 14, wherein the first camera is in an upper position and the second camera is in a lower position.

16. The system of claim 14, wherein the instructions configured to cause the computing device to map the model facial mesh to the dense facial mesh further includes differentiable rendering of the model facial mesh.

17. The system of claim 14, wherein the instructions configured to cause the computing device to map the model facial mesh to the dense facial mesh further includes with a remote computer having a machine learning model stored thereon for differentiable rendering of the model facial mesh.

18. The system of claim 14, wherein the instructions are further configured to cause the computing device to output a per-frame tracked model facial mesh of the mapped mesh.

19. The system of claim 14, wherein the instructions are further configured to cause the computing device to provide the mapped mesh to a control solver for animation.

20. A method of facial animation, the method comprising:
obtaining a stereographic actor video;
creating a dense facial mesh from the stereographic actor video;
selecting a plurality of dense landmark locations in the dense facial mesh with a machine learning model;
selecting a plurality of model landmark locations in the model facial mesh with a machine learning model;
mapping a model facial mesh to the dense facial mesh at a plurality of shared landmark locations with a non-rigid registration including differentiable rendering of the model facial mesh, wherein mapping the model facial mesh to the dense facial mesh includes a loss function including a Laplacian loss term, a landmarks loss term, a depth loss term, and a normal loss term;
keypoint tracking a mapped mesh in two-dimensional space for a plurality of frames of the stereographic actor video; and
outputting a per-frame tracked model facial mesh.
